(19) United States
(12) Patent Application Publication
(10) Pub. No.: US 2022/0338132 A1
(43) Pub. Date: Oct. 20, 2022

(54) SIDELINK POWER CONTROL FOR GROUPCAST AND BROADCAST

(71) Applicant: QUALCOMM Incorporated, San Diego, CA (US)

(72) Inventors: Seyedkianoush HOSSEINI, San Diego, CA (US); Gabi SARKIS, San Diego, CA (US); Tien Viet NGUYEN, Bridgewater, NJ (US)

(21) Appl. No.: 17/657,284

(22) Filed: Mar. 30, 2022

Related U.S. Application Data
(60) Provisional application No. 63/201,228, filed on Apr. 19, 2021.

(51) Int. Cl. H04W 52/24

(52) U.S. Cl. CPC H04W 52/248; H04W 52/242; H04W 4/06

(57) ABSTRACT

Various aspects of the present disclosure generally relate to wireless communication. In some aspects, a user equipment (UE) may determine sidelink channel transmit power for a communication based at least in part on a value of a cast type indicator field identifying whether the communication is a unicast type of communication or a non-unicast type of communication, wherein a sidelink pathloss parameter is configured for the communication. The UE may transmit the communication using the determined sidelink channel transmit power. Numerous other aspects are described.

### CROSS-REFERENCE TO RELATED APPLICATION

This Patent Application claims priority to U.S. Provisional Patent Application No. 63/201,228, filed on Apr. 19, 2021, entitled “SIDELINK POWER CONTROL FOR GROUPCAST AND BROADCAST,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sidelink power control for groupcast and broadcast.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes determining sidelink channel transmit power for a communication based at least in part on a value of a cast type indicator field identifying whether the communication is a unicast type of communication or a non-unicast type of communication, wherein a sidelink pathloss parameter is configured for the communication; and transmitting the communication using the determined sidelink channel transmit power.

In some aspects, a UE for wireless communication includes a memory, and one or more processors, coupled to the memory, configured to: determine sidelink channel transmit power for a communication based at least in part on a value of a cast type indicator field identifying whether the communication is a unicast type of communication or a non-unicast type of communication, wherein a sidelink pathloss parameter is configured for the communication; and transmit the communication using the determined sidelink channel transmit power.

In some aspects, a non-transitory computer-readable medium storing a set of instructions for wireless communication includes one or more instructions that, when executed by one or more processors of a UE, cause the UE to: determine sidelink channel transmit power for a communication based at least in part on a value of a cast type indicator field identifying whether the communication is a unicast type of communication or a non-unicast type of communication, wherein a sidelink pathloss parameter is configured for the communication; and transmit the communication using the determined sidelink channel transmit power.

In some aspects, an apparatus for wireless communication includes means for determining sidelink channel transmit power for a communication based at least in part on a value of a cast type indicator field identifying whether the communication is a unicast type of communication or a non-unicast type of communication, wherein a sidelink pathloss parameter is configured for the communication; and means for transmitting the communication using the determined sidelink channel transmit power.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example associated with sidelink power control for groupcast and broadcast, in accordance with the present disclosure.

FIG. 6 is a diagram illustrating an example process associated with sidelink power control for groupcast and broadcast, in accordance with the present disclosure.

FIG. 7 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

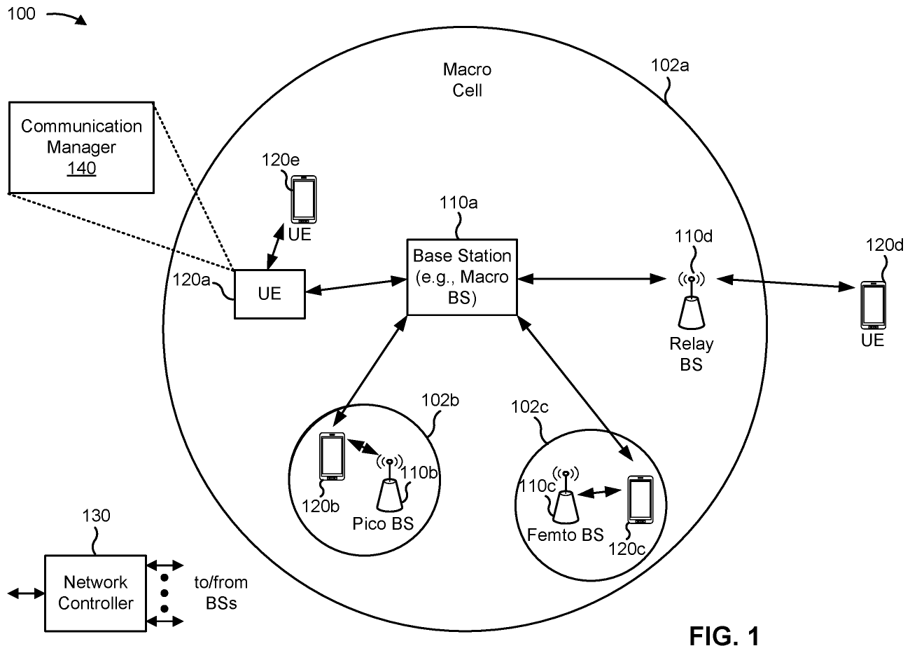

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine sidelink channel transmit power for a communication based at least in part on a value of a cast type indicator field identifying whether the communication is a unicast type of communication or a non-unicast type of communication, wherein a sidelink pathloss parameter is configured for the communication; and transmit the communication using the determined sidelink channel transmit power. Additionally, or alternatively, the communication manager 140 may perform one or more other operations described herein.

As indicated above, FIG. 1 is provided as an example. Other examples may differ from what is described with regard to FIG. 1.

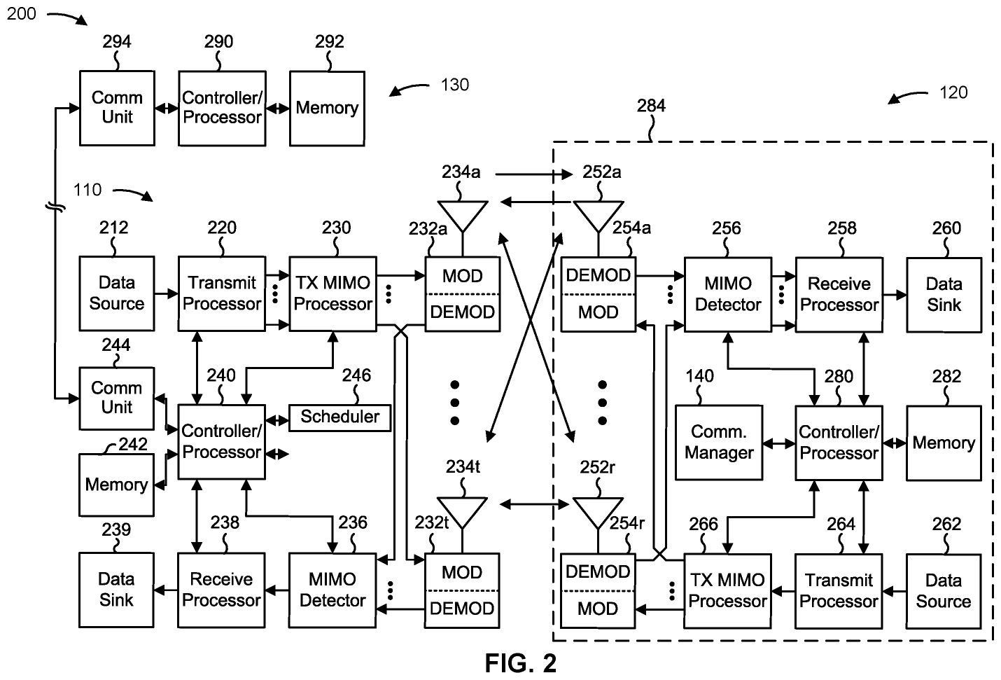

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

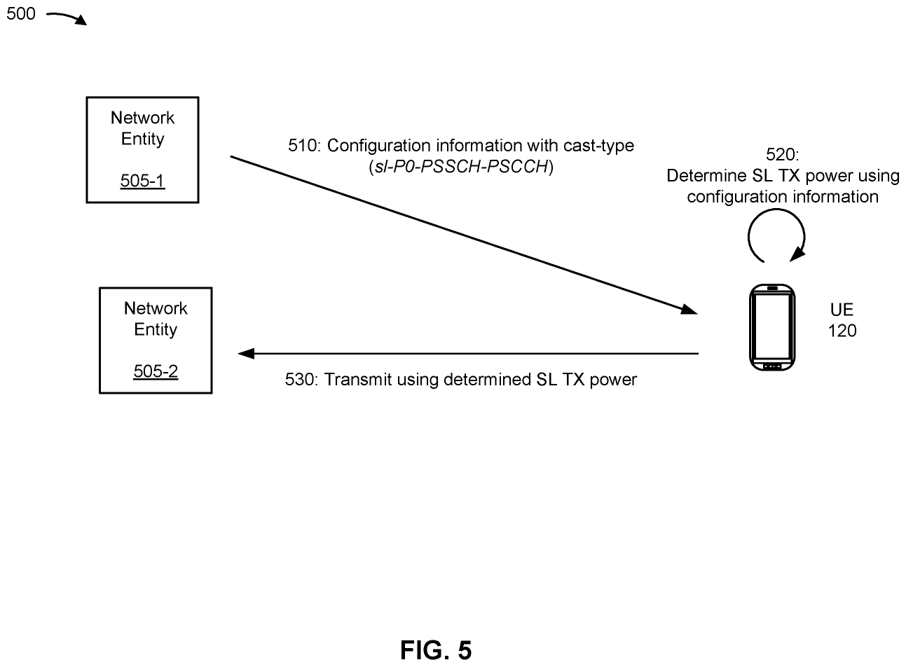

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-7).

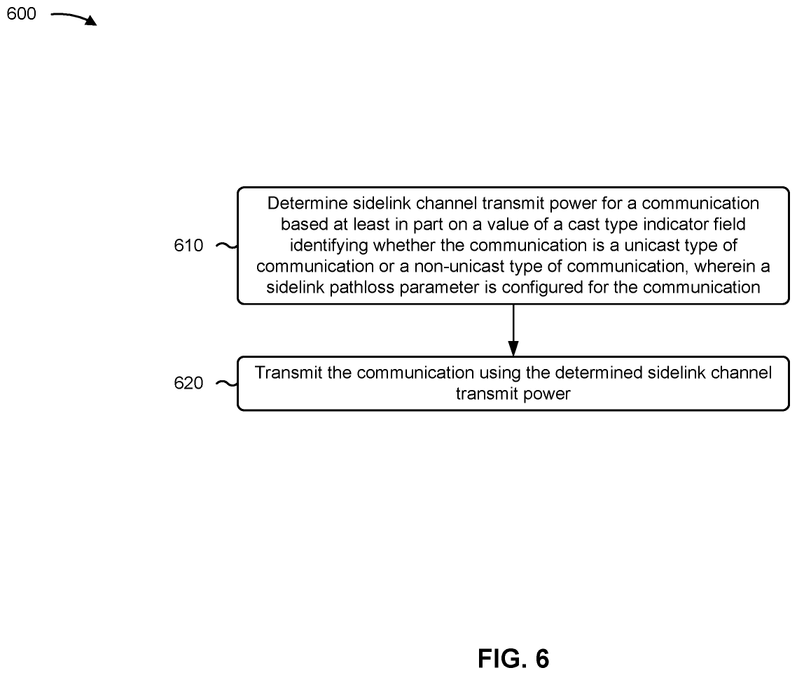

The controller/processor 240 of the base station 110, the controller/processor 280 of the UE 120, and/or any other component(s) of FIG. 2 may perform one or more techniques associated with sidelink power control for groupcast and broadcast, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6 and/or other processes as described herein. In some examples, executing instructions may include running the instructions, converting the instructions, compiling the instructions, and/or interpreting the instructions, among other examples.

In some aspects, the UE 120 includes means for determining sidelink channel transmit power for a communication based at least in part on a value of a cast type indicator field identifying whether the communication is a unicast type of communication or a non-unicast type of communication, wherein a sidelink pathloss parameter is configured for the communication; and/or means for transmitting the communication using the determined sidelink channel transmit power. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

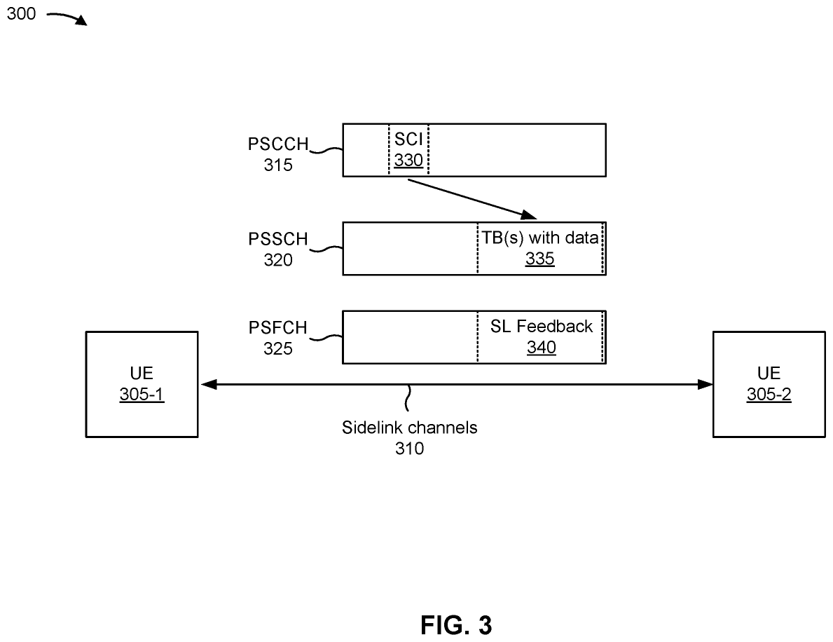

FIG. 3 is a diagram illustrating an example 300 of sidelink (SL) communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. The UEs 305 (e.g., UE 305-1 and/or UE 305-2) may correspond to one or more other UEs described elsewhere herein, such as UE 120. The one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

The one or more sidelink channels 310 may use resource pools. For example, a scheduling assignment (e.g., included in SCI 330) may be transmitted in sub-channels using specific resource blocks (RBs) across time. Data transmissions (e.g., on the PSSCH 320) associated with a scheduling assignment may occupy adjacent RBs in the same subframe as the scheduling assignment (e.g., using frequency division multiplexing). A scheduling assignment and associated data transmissions are not transmitted on adjacent RBs.

A UE 305 may operate using a transmission mode where resource selection and/or scheduling is performed by the UE 305 (e.g., rather than a base station 110). The UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. A UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

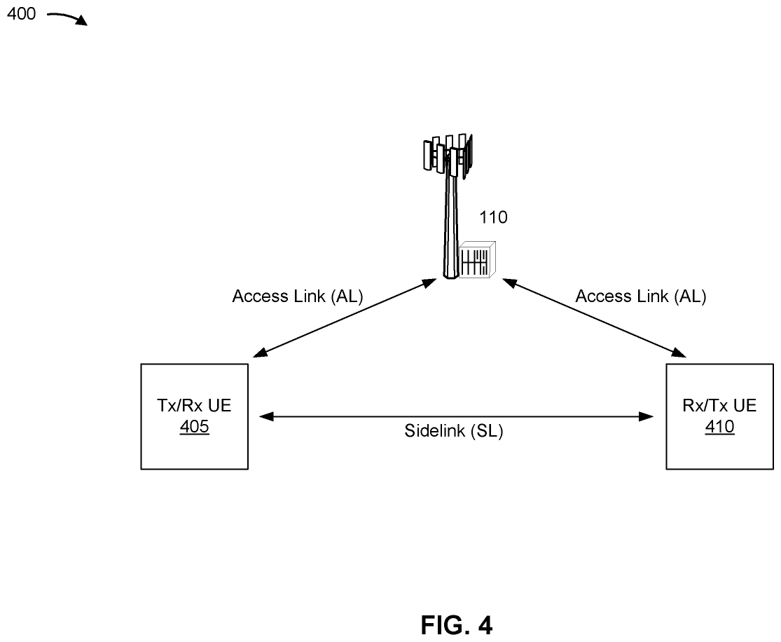

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

Sidelink power control, such as for a PSSCH, a PSCCH, a PSFCH, or a sidelink synchronization signal (SS)/physical broadcast channel (PBCH), among other examples, may be based at least in part on power control parameters, such as open loop power control parameters. For example, for a PSSCH, in one or more symbols without overlap between the PSSCH and a PSCCH, a UE may determine a transmission power for an occasion, i, according to an equation:

P_{PSSCH}(i)=min(P_{CMAX}, P_{MAX,CBR}, min(P_{PSSCH,D}(i), P_{PSSCH,SL}(i))).

In this case, P_{PSSCH} is a transmit power for the PSSCH in occasion i; P_{CMAX} is a maximum allowed power on the data channel of the PSSCH (e.g., a maximum UE transmit power associated with a power class of the UE); P_{MAX,CBR} is a maximum transmit power associated with a priority level of the PSSCH and a CBR on the data channel of the PSSCH, P_{MAX,CBR} is determinable based at least in part on a parameter sl-MaxTransPower and is based at least in part on a priority level of the PSSCH transmission and a CBR range of the channel. If the parameter, sl-MaxTransPower, is not provided, the UE may determine P_{MAX,CBR} as equivalent to P_{CMAX}.

The remaining parameters, P_{PSSCH,D}, which is a downlink pathloss based power parameter, and P_{PSSCH,SL}, which is a sidelink pathloss based power parameter, in the transmission power equation for the PSSCH are each based at least in part on a configuration of a set of P0 parameters, dl-P0-PSSCH-PSCCH and sl-P0-PSSCH,PSCCH. The first P0 parameter, dl-P0-PSSCH-PSCCH, indicates a P0 value for a downlink pathloss based power control for a PSCCH or a PSSCH. If the first P0 parameter is not configured, downlink pathloss based power control is disabled for a PSCCH or a PSSCH. Similarly, the second P0 parameter, sl-P0-PSSCH-PSCCH, indicates a P0 value for a sidelink pathloss based power control for a PSCCH or a PSSCH. If the first P0 parameter is not configured, sidelink pathloss based power control is disabled for a PSCCH or a PSSCH,

Additional details regarding sidelink power control can be found in 3GPP Technical Specification (TS) 38.213, Release 16, version 16.5.0, section 16.2.1. When sl-P0-PSSCH-PSCCH is provided to a UE and a cast type for a PSSCH transmission is unicast, the UE is enabled to calculate a transmit power. However, if sl-P0-PSSCH-PSCCH is not provided and/or the cast type is not unicast, there are three cases of interest. In a first case, sl-P0-PSSCH-PSCCH is not provided, and the cast type is not unicast (e.g., the cast type is groupcast or broadcast). In a second case, sl-P0-PSSCH-PSCCH is not provided, and the cast type is unicast. In a third case, sl-P0-PSSCH-PSCCH is provided, and the cast type is not unicast. In each of these three cases, the UE is configured to determine P_{PSSCH,SL}(i) for the aforementioned PSSCH transmit power equation according to another equation P_{PSSCH,SL}(i)=min(P_{CMAX}, P_{PSSCH,D}(i)). In other words, P_{PSCCH,SL} is dependent on P_{PSSCH,D}. For the third case, in which sl-P0-PSSCH-PSCCH is provided, P_{PSSCH,D} is dependent on P_{PSSCH,SL} according to an equation P_{PSSCH,D}(i)=min(P_{CMAX}, P_{MAX,CBR}, P_{PSSCH,SL}(i)).

Accordingly, the UE may be unable to calculate both P_{PSSCH,D} or P_{PSSCH,SL}, which may result in the UE failing to consider P_{PSSCH,D} or P_{PSSCH,SL} when calculating the PSSCH transmit power. As the PSSCH transmit power equation uses each component parameter as a transmit power maximum, failing to consider P_{PSSCH,D} or P_{PSSCH,SL} may result in the UE selecting an excessive transmit power. Alternatively, an inability to determine P_{PSSCH,D} or P_{PSSCH,SL} may result in the UE failing to select a transmit power at all, which may result in an interruption to communication services.

Some aspects described herein enable a sidelink power control determination. For example, when sl-P0-PSSCH-PSCCH is configured for a UE, the UE may determine a value for P_{PSCCH,D} using a first configuration when in a unicast transmission mode and using a second configuration when in a non-unicast (e.g., groupcast or broadcast) transmission mode. In this case, in the unicast transmission mode, the UE may determine P_{PSSCH,D} based at least in part on P_{PSSCH,SL} (which is not defined in terms of P_{PSSCH,D} for unicast transmission), and in the non-unicast transmission mode (when P_{PSSCH,SL} is defined in terms of P_{PSSCH,D}), the UE may determine a value for P_{PSSCH,D} without using P_{PSSCH,D}. For example, when a non-unicast type is configured for a transmission and sl-P0-PSSCH-PSCCH is provided, the UE may disregard the sl-P0-PSSCH-PSSCH parameter to enable a calculation of P_{PSSCH,SL} that is not dependent on P_{PSSCH,D}. In this way, the UE is enabled to determine a transmit power for PSSCH transmission.

FIG. 5 is a diagram illustrating an example 500 associated with sidelink power control for groupcast and broadcast, in accordance with the present disclosure. As shown in FIG. 5, example 500 includes communication between network entities 505 and a UE 120. In some aspects, network entities 505 and UE 120 may be included in a wireless network, such as wireless network 100. Network entity 505 and UE 120 may communicate via a wireless access link, which may include an uplink, a downlink, or a sidelink.

As further shown in FIG. 5, and by reference number 510, UE 120 may receive configuration information associated with a transmission. For example, UE 120 may receive configuration information, from network entity 505-1, indicating a cast type for a transmission, such as a non-unicast cast type (e.g., broadcast or groupcast). Additionally, or alternatively, UE 120 may receive configuration information including a power control parameter. For example, UE 120 may receive information identifying a value for sl-P0-PSSCH-PSCCH.

As further shown in FIG. 5, and by reference number 520, UE 120 may determine a sidelink transmit power using the configuration information. For example, UE 120 may determine the sidelink transmit power for a PSSCH transmission based at least in part on the configuration information. In some aspects, UE 120 may determine the sidelink transmit power based at least in part on the cast type being unicast. For example, when sl-P0-PSSCH-PSCCH is provided and the PSSCH transmission is associated with a cast type indicator field indicating unicast, UE 120 may determine P_{PSSCH,D} based at least in part on an equation P_{PSSCH,D}(i)=min(P_{CMAX}, P_{MAX,CBR}, P_{PSSCH,SL}(i)).

In some aspects, UE 120 may disregard or forgo using a received parameter when determining the sidelink transmit power. For example, when UE 120 is provided the sl-P0-PSSCH-PSCCH parameter for determination of P_{PSSCH,SL}(i) and the transmission type is a non-unicast transmission type, UE 120 may disregard the sl-P0-PSSCH-PSCCH parameter. In other words, UE 120 may determine P_{PSSCH,SL}(i) as if UE 120 had not received the sl-P0-PSSCH-PSCCH parameter, thereby enabling UE 120 to determine P_{PSSCH,SL} and P_{PSSCH,D} without P_{PSSCH,SL} and P_{PSSCH,D} having a circular dependency on each other.

In some aspects, UE 120 may determine P_{PSSCH,SL} based at least in part on an equation P_{PSSCH,SL}(i)=min(P_{CMAX}, P_{PSSCH,D}(i)). In this case, although P_{PSSCH,SL} is dependent on P_{PSSCH,D,} UE 120 may calculate P_{PSSCH,D} without using P_{PSSCH,SL} based at least in part on sl-P0-PSSCH-PSCCH being provided, thereby avoiding the circular dependency. For example, UE 120 may determine P_{PSSCH,D} based at least in part on a first equation: P_{PSSCH,D}(i)=P_{O,D}+10 log₁₀(2μ·M_{RB}^{PSSCH}(i))+α_{D}, where α (alpha) and PL (pathloss) are pathloss values configured by base station 110 or statically configured, P_{O,D} is the value of P0-DL-PSSCH-PSCCH if provided, and M is a quantity of resource blocks for the PSSCH transmission occasion. Additionally, or alternatively, when P0-DL-PSSCH-PSCCH is not provided, UE 120 may determine P_{PSSCH,D} based at least in part on a second equation P_{PSSCH,D}(i)=min(P_{CMAX}, P_{MAX,CBR}). In each case, P_{PSSCH,D} is not dependent on P_{PSSCH,SL} so P_{PSSCH,SL} can be dependent on P_{PSSCH,D} without causing a circular dependency and an associated error in UE power calculation.

As further shown in FIG. 5, and by reference number 530, UE 120 may transmit using the determined sidelink transmit power. For example, UE 120 may transmit, to network entity 505-2, a PSSCH transmission (e.g., with a particular cast type, such as unicast, broadcast, or groupcast) based at least in part on determining a transmit power P_{PSSCH} from a pathloss transmit power, such as P_{PSSCH,D} or P_{PSSCH,SL}, as described above.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with sidelink power control for groupcast and broadcast.

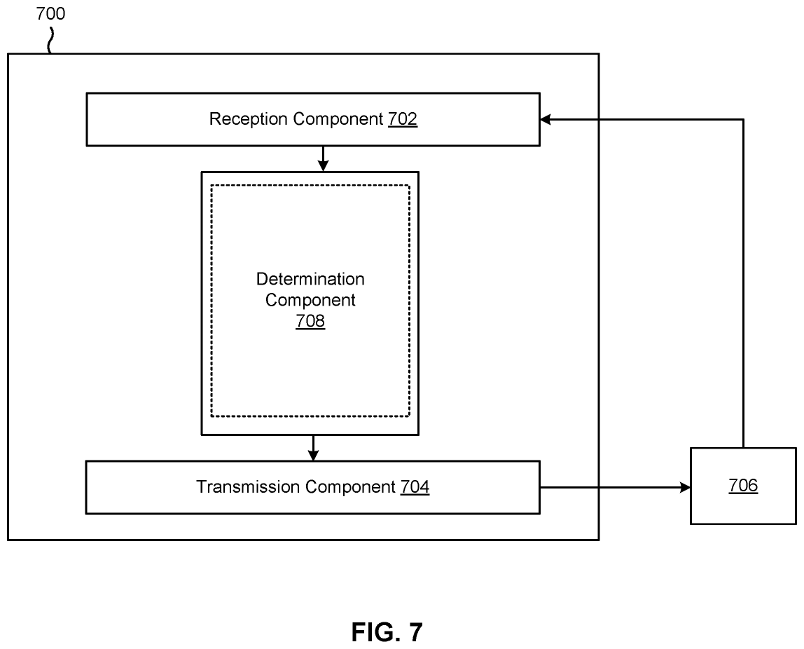

As shown in FIG. 6, in some aspects, process 600 may include determining sidelink channel transmit power for a communication based at least in part on a value of a cast type indicator field identifying whether the communication is a unicast type of communication or a non-unicast type of communication, wherein a sidelink pathloss parameter is configured for the communication (block 610). For example, the UE (e.g., using determination component 708, depicted in FIG. 7) may determine sidelink channel transmit power for a communication based at least in part on a value of a cast type indicator field identifying whether the communication is a unicast type of communication or a non-unicast type of communication, wherein a sidelink pathloss parameter is configured for the communication, as described above.

As further shown in FIG. 6, in some aspects, process 600 may include transmitting the communication using the determined sidelink channel transmit power (block 620). For example, the UE (e.g., using transmission component 704, depicted in FIG. 7) may transmit the communication using the determined sidelink channel transmit power, as described above.

Process 600 may include additional aspects, such as any single aspect or any combination of aspects described below and/or in connection with one or more other processes described elsewhere herein.

In a first aspect, the communication is a groupcast communication or a broadcast communication, and determining the sidelink channel transmit power comprises determining the sidelink channel transmit power without using the sidelink pathloss parameter.

In a second aspect, alone or in combination with the first aspect, the communication is a groupcast communication or a broadcast communication, and determining the sidelink channel transmit power comprises determining the sidelink channel transmit power based at least in part on a maximum UE transmit power parameter or a downlink pathloss parameter.

In a third aspect, alone or in combination with one or more of the first and second aspects, the downlink pathloss parameter is based at least in part on at least one of the maximum UE transmit power parameter, a channel busy ratio parameter, a downlink pathloss P0 parameter, a downlink alpha parameter, a reference signal power parameter, or a quantity of resource blocks for a sidelink channel occasion.

In a fourth aspect, alone or in combination with one or more of the first through third aspects, the sidelink pathloss parameter is a sidelink P0 pathloss parameter.

In a fifth aspect, alone or in combination with one or more of the first through fourth aspects, the sidelink channel is a physical sidelink shared channel without overlap with a physical sidelink control channel.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include one or more of a determination component 708, among other examples.

In some aspects, the apparatus 700 may be configured to perform one or more operations described herein. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The determination component 708 may determine sidelink channel transmit power for a communication based at least in part on a value of a cast type indicator field identifying whether the communication is a unicast type of communication or a non-unicast type of communication, wherein a sidelink pathloss parameter is configured for the communication. The transmission component 704 may transmit the communication using the determined sidelink channel transmit power.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: determining sidelink channel transmit power for a communication based at least in part on a value of a cast type indicator field identifying whether the communication is a unicast type of communication or a non-unicast type of communication, wherein a sidelink pathloss parameter is configured for the communication; and transmitting the communication using the determined sidelink channel transmit power.

Aspect 2: The method of Aspect 1, wherein the communication is a groupcast communication or a broadcast communication, and wherein determining the sidelink channel transmit power comprises: determining the sidelink channel transmit power without using the sidelink pathloss parameter.

Aspect 3: The method of any of Aspects 1 to 2, wherein the communication is a groupcast communication or a broadcast communication, and wherein determining the sidelink channel transmit power comprises: determining the sidelink channel transmit power based at least in part on a maximum UE transmit power parameter or downlink pathloss parameter.

Aspect 4: The method of Aspect 3, wherein the downlink pathloss parameter is based at least in part on at least one of the maximum UE transmit power parameter, a channel busy ratio parameter, a downlink pathloss P0 parameter, a downlink alpha parameter, a reference signal power parameter, or a quantity of resource blocks for a sidelink channel occasion.

Aspect 5: The method of any of Aspects 1 to 4, wherein the sidelink pathloss parameter is a sidelink P0 pathloss parameter.

Aspect 6: The method of any of Aspects 1 to 5, wherein the sidelink channel is a physical sidelink shared channel without overlap with a physical sidelink control channel.

Aspect 7: An apparatus for wireless communication at a device, comprising a processor; memory coupled with the processor; and instructions stored in the memory and executable by the processor to cause the apparatus to perform the method of one or more Aspects of Aspects 1-6.

Aspect 8: A device for wireless communication, comprising a memory and one or more processors coupled to the memory, the memory and the one or more processors configured to perform the method of one or more Aspects of Aspects 1-6.

Aspect 9: An apparatus for wireless communication, comprising at least one means for performing the method of one or more Aspects of Aspects 1-6.

Aspect 10: A non-transitory computer-readable medium storing code for wireless communication, the code comprising instructions executable by a processor to perform the method of one or more Aspects of Aspects 1-6.

Aspect 11: A non-transitory computer-readable medium storing a set of instructions for wireless communication, the set of instructions comprising one or more instructions that, when executed by one or more processors of a device, cause the device to perform the method of one or more Aspects of Aspects 1-6.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
determining sidelink channel transmit power for a communication based at least in part on a value of a cast type indicator field identifying whether the communication is a unicast type of communication or a non-unicast type of communication, wherein a sidelink pathloss parameter is configured for the communication; and
transmitting the communication using the determined sidelink channel transmit power.

2. The method of claim 1, wherein the communication is a groupcast communication or a broadcast communication, and
wherein determining the sidelink channel transmit power comprises:
determining the sidelink channel transmit power without using the sidelink pathloss parameter.

3. The method of claim 1, wherein the communication is a groupcast communication or a broadcast communication, and
wherein determining the sidelink channel transmit power comprises:
determining the sidelink channel transmit power based at least in part on a maximum UE transmit power parameter or downlink pathloss parameter.

4. The method of claim 3, wherein the downlink pathloss parameter is based at least in part on at least one of the maximum UE transmit power parameter, a channel busy ratio parameter, a downlink pathloss P0 parameter, a downlink alpha parameter, a reference signal power parameter, or a quantity of resource blocks for a sidelink channel occasion.

5. The method of claim 1, wherein the sidelink pathloss parameter is a sidelink P0 pathloss parameter.

6. The method of claim 1, wherein the sidelink channel is a physical sidelink shared channel without overlap with a physical sidelink control channel.

7. A user equipment (UE) for wireless communication, comprising:
a memory; and
one or more processors, coupled to the memory, configured to:
determine sidelink channel transmit power for a communication based at least in part on a value of a cast type indicator field identifying whether the communication is a unicast type of communication or a non-unicast type of communication, wherein a sidelink pathloss parameter is configured for the communication; and
transmit the communication using the determined sidelink channel transmit power.

8. The UE of claim 7, wherein the communication is a groupcast communication or a broadcast communication, and
wherein the one or more processors, to determine the sidelink channel transmit power, are configured to:
determine the sidelink channel transmit power without using the sidelink pathloss parameter.

9. The UE of claim 7, wherein the communication is a groupcast communication or a broadcast communication, and
wherein the one or more processors, to determine the sidelink channel transmit power, are configured to:
determine the sidelink channel transmit power based at least in part on a maximum UE transmit power parameter or downlink pathloss parameter.

10. The UE of claim 9, wherein the downlink pathloss parameter is based at least in part on at least one of the maximum UE transmit power parameter, a channel busy ratio parameter, a downlink pathloss P0 parameter, a downlink alpha parameter, a reference signal power parameter, or a quantity of resource blocks for a sidelink channel occasion.

11. The UE of claim 7, wherein the sidelink pathloss parameter is a sidelink P0 pathloss parameter.

12. The UE of claim 7, wherein the sidelink channel is a physical sidelink shared channel without overlap with a physical sidelink control channel.

13. A non-transitory computer-readable medium storing a set of instructions for wireless communication, the set of instructions comprising:
one or more instructions that, when executed by one or more processors of a user equipment (UE), cause the UE to:
determine sidelink channel transmit power for a communication based at least in part on a value of a cast type indicator field identifying whether the communication is a unicast type of communication or a non-unicast type of communication, wherein a sidelink pathloss parameter is configured for the communication; and
transmit the communication using the determined sidelink channel transmit power.

14. The non-transitory computer-readable medium of claim 13, wherein the communication is a groupcast communication or a broadcast communication, and
wherein the one or more instructions, that cause the UE to determine the sidelink channel transmit power, cause the UE to:
determine the sidelink channel transmit power without using the sidelink pathloss parameter.

15. The non-transitory computer-readable medium of claim 13, wherein the communication is a groupcast communication or a broadcast communication, and
wherein the one or more instructions, that cause the UE to determine the sidelink channel transmit power, cause the UE to:
determine the sidelink channel transmit power based at least in part on a maximum UE transmit power parameter or downlink pathloss parameter.

16. The non-transitory computer-readable medium of claim 15, wherein the downlink pathloss parameter is based at least in part on at least one of the maximum UE transmit power parameter, a channel busy ratio parameter, a downlink pathloss P0 parameter, a downlink alpha parameter, a reference signal power parameter, or a quantity of resource blocks for a sidelink channel occasion.

17. The non-transitory computer-readable medium of claim 13, wherein the sidelink pathloss parameter is a sidelink P0 pathloss parameter.

18. The non-transitory computer-readable medium of claim 13, wherein the sidelink channel is a physical sidelink shared channel without overlap with a physical sidelink control channel.

19. An apparatus for wireless communication, comprising:
means for determining sidelink channel transmit power for a communication based at least in part on a value of a cast type indicator field identifying whether the communication is a unicast type of communication or a non-unicast type of communication, wherein a sidelink pathloss parameter is configured for the communication; and
means for transmitting the communication using the determined sidelink channel transmit power.

20. The apparatus of claim 19, wherein the communication is a groupcast communication or a broadcast communication, and
wherein the means for determining the sidelink channel transmit power comprises:
means for determining the sidelink channel transmit power without using the sidelink pathloss parameter.

21. The apparatus of claim 19, wherein the communication is a groupcast communication or a broadcast communication, and
wherein the means for determining the sidelink channel transmit power comprises:
means for determining the sidelink channel transmit power based at least in part on a maximum UE transmit power parameter or downlink pathloss parameter.

22. The apparatus of claim 21, wherein the downlink pathloss parameter is based at least in part on at least one of the maximum UE transmit power parameter, a channel busy ratio parameter, a downlink pathloss P0 parameter, a downlink alpha parameter, a reference signal power parameter, or a quantity of resource blocks for a sidelink channel occasion.

23. The apparatus of claim 19, wherein the sidelink pathloss parameter is a sidelink P0 pathloss parameter.

24. The apparatus of claim 19, wherein the sidelink channel is a physical sidelink shared channel without overlap with a physical sidelink control channel.
